(19) United States
(12) Patent Application Publication
(10) Pub. No.: US 2004/0215654 A1
(43) Pub. Date: Oct. 28, 2004

(54) Total liability compliance (TLC) system

(76) Inventors: David Brent Eberwine, Lucas, TX (US); Mark Alan Eberwine, San Antonio, TX (US)

Correspondence Address: David Eberwine, 270 Holly Ln, Lucas, TX, 75002, US

(21) Appl. No.: 10/829,788

(22) Filed: Apr. 22, 2004

Related U.S. Application Data
(60) Provisional application No. 60/465,629, filed on Apr. 28, 2003.

(51) Int. Cl. G06F 7/00

(52) U.S. Cl. 707/102

(57) ABSTRACT

A system and method for the real time verification of automobile liability insurance using multiple interconnected computer systems providing insurance verification to one or more validate users. The system utilizes user validation and direct or indirect routing to both find and to protect the data location.

### CROSS REFERENCE TO RELATED APPLICATIONS

This non-provisional patent application claims benefit from provisional patent filing 60/465,629 filed Apr. 28, 2003.

### STATEMENT REGARDING FEDERALLY SPONSORED RESEARCH OR DEVELOPMENT

Not applicable.

### REFERENCE TO COMPUTER LISTINGS, ETC.

Not applicable.

### BACKGROUND OF INVENTION

Currently, the state of Texas and several other states require proof of liability insurance for every registered and operated vehicle. Typically that proof of insurance is a paper card carried in the glove compartment of the vehicle. The deficiencies of the current paper card based proof coverage is that the card is easily counterfeited (duplicated and created falsely) and the coverage was effective for the issuance of the card but is not necessarily in effect after the card was received by the insured. Also a percentage of motorists carry a card which was illegally obtained (either bought from a counterfeiter or printed by oneself). Additionally, insurance policies are started and then when the proof of insurance card is received by the insured, the insurance is cancelled yet the card is carried by the individual and presented as verification of a current policy even though there is no current insurance in effect. There currently is no timely, economical, real time method to verify that the insurance coverage indicated by the paper card is valid. The end result is the carrying of a card that does not indicate a nonexistent or canceled policy. Also, drivers can be ticketed in the morning and can purchase and have an active policy that afternoon. Insurance companies refuse to combine insurance data into a single database for centralized verification which enforcement agencies can access for fear of client information being accessed by a competitor or other unauthorized entity.

This system and method of instant information verification specifically targets the shortcomings of the current paper card based vehicle insurance identification issued by insurance companies and carried by motorists across the nation. By utilizing the same methods but with different presentation interfaces, this instant information verification system also provides the capability to perform medical insurance verification, identity verification (query to one or more locations) and can perform instant background checks (simultaneous query to one or more agencies) for gun owners.

In this new approach, a new insurance card is issued to each vehicle. The new card contains barcoded information, or magnetic encoded information, or is a Radio Frequency Identification (RFID) transponder with stored information. This information consists of the unique Vehicle Identification Number (VIN)and/or license plate number, a translation control code (TCC) and a home Identifier (HID) (the translation control code and home identifier are collectively referred to as the Homing Tag). The translation control code, home identifier and VIN can be combined into a single one dimension encoding, single multidimensional encoding or may be one or more separate encoding with delimiters. In the preferred embodiment, the information is encoded in a machine readable encoding such as a standard barcode to minimize the impact to existing systems.

The system (and method) is initiated when a barcode scanner is utilized to read the Homing Tag and VIN barcode(s), read the Homing Tag and License Plate number, or is initiated on a computer after a keyboard “Enter” key is pressed following a barcode scan or manual entry of the encoded information or is initiated by RF scan of the RFID transponder. A software routine extracts and applies the Homing tag data to a translation/routing table which returns the network (Internet) address of the specific insurance company to send the electronic information request. The software routine then creates a message containing a message type tag, requester ID and address, an optional security access code, and the VIN code and sends it to the insurance company across the Internet. Software located at the insurance company (the other end of the internet link) receives the Internet message, decodes that it is an insurance status request, performs a local database lookup for the insurance status, builds a response message with the appropriate information (owner, license plate number, insurance status for example: active, canceled, or non-existent) and sends the response message via the Internet back to the original requester using the received requester address. The software that originated the request receives the message and displays the information in a custom format.

As part of this business method for enforcement of mandated insurance, a mobile enforcement capability is provided by providing law enforcement agencies an internet capable cellular phone or other wireless device (i.e. wireless Palm Pilot, etc.) utilizing stored program control and a built in camera to perform the same functions as a computer with a barcode scanner. Software exists today to convert a still image of barcodes to a standard barcode scan output. In this case, the image capture of the camera initiates the information request and the result is displayed on the wireless device. In the preferred embodiment, the business method for mobile enforcement includes an Application Programming Interface (API) which allows a third party software company (specifically, the company which created/supports the police cruiser based vehicle registration query system) to perform an insurance verification information request. This method requires a Homing Tag be displayed on the license plate or other visible location on the vehicle. The homing tag would be a sticker with, for example, three characters (letters and numbers) applied to the license plate or to the vehicle in a visible location. The officer today enters the license plate number into the in-cruiser system. The officer will take the additional step of entering the Homing Tag information. The in-cruiser system using it's stored program control will combine the License plate number and the Homing Tag information and provide it to the API. The API itself is a stored program control and will perform the information request and return the result to the fixed or hand held terminal in the cruiser where it is displayed to the officer. In an alternate embodiment, as shown in FIG. 6, the routing key is stored as field in the vehicle registration database

Variations to the System

The Internet connection at either or both ends can be a wireless connection or a Local Area Network (LAN) or Virtual Private Netowork (VPN).

Note that this same method and system works with an RFID tag and RFID tag reader replacing the barcode and scanner respectively and also a magnetic card and magnetic card reader replacing the barcode and scanner respectively or smart card and smart card reader replacing the barcode and scanner respectively.

A variation on the system is to have all initiations go to a single centralized lookup table (as opposed to the distributed method previously described).

The patented items will include the method described previously which includes a transaction across the internet initiated by a bar code scan, magnetic stripe scan, retina/fingerprint scan or RFID tag scan, and distributed routing tables or a centralized routing table to allow multiple companies to share the same communications infrastructure for what is effectively a distributed database system where the database is distributed among differing companies or state and federal agencies.

When the insurance companies are comfortable providing information to a common database, the Homing Tag per vehicle can be replaced with a License plate database which contains the routing information so that the mobile enforcement capability is only required to enter the license plate number. The license plate number is used as an index into the stated database to return either the Homing Tag or can contain the actual status of insurance. Such a database exists today in most states and it is typically referred to as the Vehicle Registration Database and is indexed by the vehicle license plate number. This database record that exists today can be expanded to contain the homing tag or that actual status of insurance.

### SUMMARY OF INVENTION

The following goes together to form a new system and method to automate and assist the proper agencies, law enforcement, and other personnel in the immediate verification of information contained at one or more of many remote locations. This system preferably utilizes the Internet as a wide area network to connect corporations or individual users with disparate computer systems or otherwise non-connected competing companies or Federal, State, and Local Governmental agencies in a manner such that specific information can be retrieved without the use of a common collective database or singular routing hub. A singular routing hub is not excluded from this patent however it would limit the throughput of the system and provide a single point of surveillance thus is not the preferred embodiment. The system could also be implemented over a private Local Area Network, Wide Area Network, or Virtual Private Network as the communication system interconnectivity. The system is a closed system in that only authorized requests are processed (the requester is authenticated). The system utilizes proprietary commands and responses and application specific user interfaces to interact with one of many existing information storage subsystems. In its initial implementation, the system will be used to verify, in real time, the current status of automobile liability insurance and optionally, state vehicle registration information, identity verification, and background criminal information in an instant background check (i.e. for purchases and passenger screening). The system supports all types of data verification (i.e. medical, criminal, etc.).

### BRIEF DESCRIPTION OF THE DRAWINGS

FIG. 1 is an illustration of high level overview of the system.

FIG. 2 is an illustration of the User Subsystem (US) used in the preferred embodiment of the present invention. There are N (one or more, no specified limit) User Subsystems utilized in the system however only one is shown for description.

FIG. 3 is an illustration of the Data Server Subsystem (DSS) used in the preferred embodiment of the present invention. There are N Data Server Subsystems utilized in the system however only one is shown for description.

FIG. 4 is an illustration of the Control and Maintenance (C&M) Subsystem used in the preferred embodiment of the present invention. There is only 1 Control and Maintenance Subsystem utilized in the system however the system does not preclude the use of more than one Maintenance Subsystem for redundancy purposes of Administration of the overall system.

FIG. 5 is an illustration of the various input devices that are connected to the User Subsystem in various configurations.

FIG. 6 is an illustration of the Insurance Compliance System showing the basic configuration.

### DESCRIPTION OF THE PREFERRED EMBODIMENT

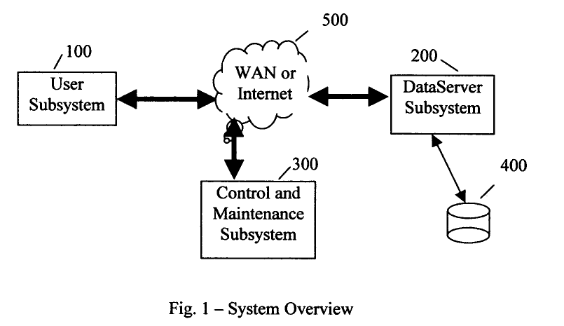

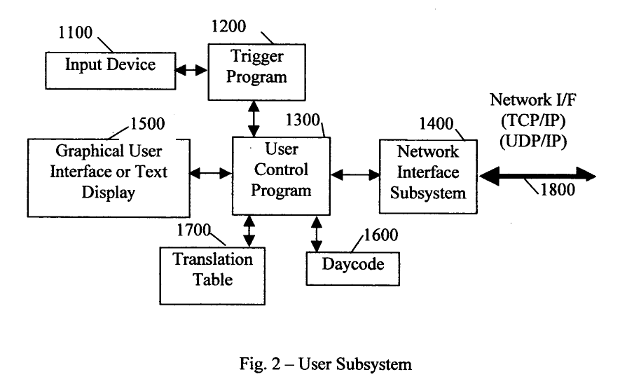

Referring to FIG. 1, In the preferred embodiment, the system is viewed as having three major components: one or more User Subsystems (100, multiple), one or more Data Server Subsystems (DSS, 200, multiple), and one or more Control and Maintenance Subsystems (300, one or more for redundancy) all interconnected and communicating with each other via a network (500) (a WAN, the Internet, etc.). The DSS contains the Database (400). The three subsystems are further viewed in FIGS. 2, 3, and 4 and are described in detail as follows.

User Subsystem

Overview

Referring to FIG. 2, in the preferred embodiment the User Subsystem consists of a input device (1100, barcode scanner, magnetic stripe reader, or RFID reader), a trigger program (1200), a User Control Program (UCP) (1300), a Network Interface Subsystem (NIS) (1400), a Graphical User Interface (GUI) or text display (1500), a Daycode table (1600), a translation table (1700), and a Network Interface (1800). Note that the User Subsystem can utilize a wireless interface to the Internet (i.e. cellular phone or Personal Digital Assistant, laptop with wireless modem, etc.) to provide a non-tethered, remote information verification system.

Query Build and Send

In the preferred embodiment, the barcode scanner will scan an insurance card containing the Homing Tag (HT) and Data Key (Vehicle Identification Number (VIN) or license plate number) (collectively referred to as trigger data). The Homing Tag consists of the combination of the translation control code (TCC) and the Homing ID (HID). The TCC identifies the translation method to be applied to the HID (don't translate, translate with specific table). The HID is either a direct routing address or is a key into a translation table containing the routing address. The trigger data will be parsed by the trigger program (1200) and will be input to the User Control Program (UCP, 1300). The User Control Program will evaluate the TCC to determine if the HID is absolute or should be translated. If the TCC indicates to not translate (the HID is absolute), it is used as the network address directly for the data query. If the TCC indicates a non-absolute HID, the TCC indicates which translation table (1700) to utilize and the HID is translated into the network address. The network address contained in the translation table is either the Network Domain Name of the specific Data Server Subsystem or the absolute network address of the required form (i.e. nnn.nnn.nnn.nnn as specified by Internet Protocol).

The User Control Program creates a network data query using the HID, the user subsystem identifier (UID), User Network Address, the Daycode, the Translation Table ID, and the data key (VIN or license plate number) and passes the query to the Network Interface Subsystem (NIS, 1400) for network transport. The NIS provides a standard UDP/IP and TCP/IP interface to the network using the HID based network address as the destination for the query. The destination is a Data Server Subsystem. A timer is started when the query is sent and allowing up to N queries to be initiated again if a response is not received within a preset time.

Query Response Receipt

The User Control program receives network query responses from the Data Server Subsystem that received the query. The timer associated with the query is cancelled. The data is displayed in a predetermined application specific format.

Daycode Update

The User Subsystem receives periodically, at least once per day, a Daycode from the Control and Maintenance Subsystem (CMS) during the authentication process. The Daycode is the daily authorization code and improves the efficiency of the overall system by performing authorization once per day. The Daycode is included in each query to the DSS as the per transaction authentication method.

Translation Table Updates

The User Control Program contained within the User Subsystem provides local update capability of the Translation Table entries via interaction across the Network with the Control and Maintenance Subsystem. The Translation Tables entries are added, deleted, or changed. The entire table can be replaced by the CMS. The Translation Tables are used by the User Subsystems to locate and access the Data Server Subsystems.

Additionally, the UCP initiates a whole table update query if no table exists or the table becomes stale (contains old or otherwise incorrect entries). The UCP first tries to access the CMS. If a data query is made to a Data Server Subsystem and that specific Data Server Subsystem determines that the table is stale (via the table ID sent in the data query), the Data Server Subsystem will initiate a Translation Table update with the User Subsystem.

Additional Capability for Instant Background Check

In the case of the user subsystem performing an instant background check system, the user subsystem can perform queries to one or more static destinations. For example, the initiating of a query using a fingerprint scanner would be to the FBI, local police, department of homeland security, and department of public safety. The user subsystem would display the aggregate response when all the outstanding queries are received.

Data Server Subsystem

Overview

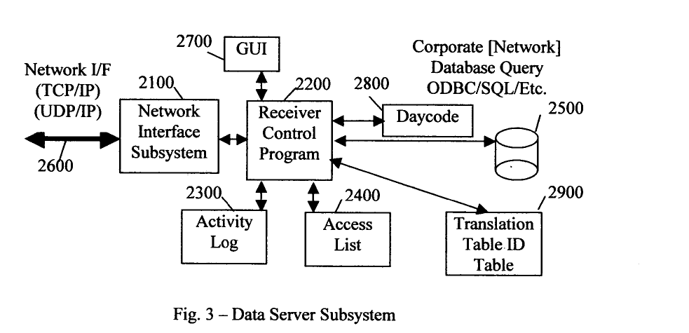

Referring to FIG. 3, in the preferred embodiment the Data Server Subsystem consists of a Network Interface (2600), a Network Interface Subsystem (2100), a Receiver Control program (2200), a GUI (2700), an activity log (2300), an access list (2400), a database or data file (2500), a Daycode table (2800), and a translation table ID table (2900).

Query Reception

In the preferred embodiment, the Data Server Subsystem (DSS) receives a query from a User Subsystem via the Network Interface (2600) to the Network Interface Subsystem (2100). The NIS provides a secure transaction capability such as SSL. The user query is parsed by the Receiver Control Program (RCP, 2200) and the received Daycode is verified against the daycode (2800) for validation of user access. If the Daycode is invalid, the UID, Network address, and time received are logged in the activity log (2300). In addition to or in lieu of the Daycode validation, the received UID is verified against the access list (2400). The Daycode is unique to the system, calculated at the start of the day, and is sent to each User Subsystem upon authentication once per day by the user to the CMS.

After validation of the source of the query, the Receiver Control Program creates a database query using the required database query language for the location (ODBC, SQL, etc.) and performs the query to the database or data file (2500).

A Graphical User Interface (GUI, 2700) is available to view the activity log, modify the access list, and update the Daycode manually.

For background checks, the DSS has the additional ability under stored program control in the receiver subsystem (2200) to perform one or more data queries to other DSS, accumulate the responses and send an aggregate response to the initiating user subsystem.

Detection of Stale Translation Table

Additionally, the received user's Translation Table ID is checked to determine if the translation table is stale. If the received table ID does not match the value contained in the translation table ID table the User Subsystem translation table is considered stale (old or containing expired data), the Data Server Subsystem, if enabled to do so, initiates a Translation Table update to that specific User or sends a Table update notification to the CMS so that the CMS can initiate the Table Update.

Query Response

The response to the database query is constructed by the Receiver Control program into a response to the network address of the original requester. The response, addressed to the network address of the UID, contains optionally any combination of the VIN, license plate number, make, model, year of auto, and expiration date of the insurance policy or an insurance valid flag of “current”, “expired”, or “cancelled”. If the database query results in a failure to find the information, the validity flag of “not found” is returned in the response query. The response to the query is logged in the activity log.

If a Daycode was not received or was incorrect by the sender, the DSS will optionally validate the UID against the access list and after validation of the UID, the current Daycode is sent to the user for subsequent queries (faster validation).

Monitor GUI

The Data Server Subsystem contains local terminal access via a custom GUI for the purpose of local table viewing and updates. The GUI provides access to the access list, query log, Receiver ID, all tables, and the Daycode.

Query Log Requests

The Data Server Subsystem accepts requests from the CMS for the query log. The Query log is transferred to the CMS and upon receipt acknowledge of the transfer, is initialized to zero entries. The query log contains failed validations for security uses and optionally database results for per transaction billing capability. As an option, the Query log can be processed for billing data locally if the insurance companies do not wish to have the non failed queries collected external to their company.

Access List Updates

The Data Server Subsystem accepts Access List updates from the CMS. The updates are individual entry updates or entire list updates. The update is accepted after the CMS identification is authenticated.

Control and Maintenance Subsystem

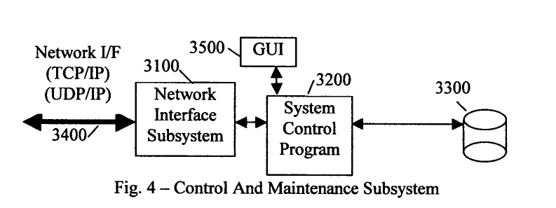

Referring to FIG. 4, in the preferred embodiment the Control and Maintenance Subsystem (CMS) consists of a Network Interface (3400), a Network Interface Subsystem (3100), a System Control program (3200), a GUI (3500), and a database or data file (3300) containing one or more system tables.

The CMS provides User and Authentication methods for all DSS and User Subsystems. The CMS provides access list updates to the Data Server Subsystems and Daycode updates to all DSS and User Subsystems. The CMS also requests and receives the Query logs from the Data Server Subsystems. The CMS is also referred to as the Administrative Subsystem.

Receiver List Updates

The CMS provides local update capability of the Receiver list entries. The Receiver list entries are added, deleted, or changed. The Receiver list is used to provide destinations to the CMS for propagating Access List updates. The receiver list is a superset of the Translation Table entries containing additional system security information. The Receiver List, as with all other tables maintained by the CMS is maintained on the Storage Subsystem (3300).

Translation Table Updates

The CMS provides local update capability of the Translation Table entries. The Translation Tables entries are added, deleted, or changed. The Translation Tables are used by the User Subsystems to locate and access the Data Server Subsystems. Translation Table updates can be forced immediately by changing the Daycode forcing re-authentication of all user subsystems, or can be delayed to occur at the next user authentication period.

Access List Updates

The CMS provides local update capability of the access list entries. The access list entries are added, deleted, or changed. As an option, after update of an individual entry, the individual entry is propagated to all Data Server Subsystems contained within the Receiver List, via the network. Optionally, the entire list is broadcast to all Data Server Subsystems contained in the Receiver List.

Query log Requests

The CMS periodically polls all Data Server Subsystems for their Query logs. The Query logs are extracted and billing data is created from the query data.

User Access List

The CMS stores a user access list in the database (3300) A GUI is provided to add and delete users from the user access list. The login and password of the user subsystem are stored in the database. Users can also be marked as disallowed to explicitly deny access.

DSS Access List

The CMS stores a DSS access list in the database (3300) A GUI is provided to add and delete DSS from the user access list. The login and password of the DSS are stored in the database.

Application Programming Interface

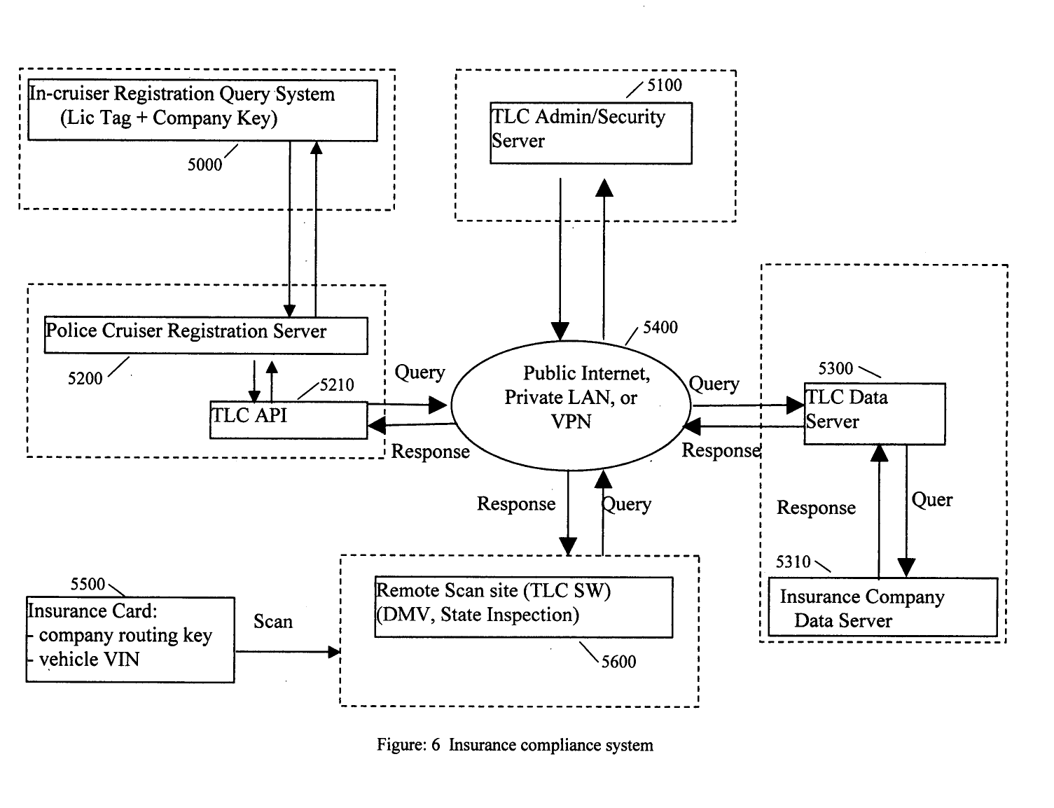

Referring to FIG. 6, in addition to specific user interfaces, an application programming interface (API) (FIG. 6, 5210) is available to allow external or third party systems (5000, 5200) to perform queries into the system. The API is actually a collection of several APIs. The third party program (5000 and 5200) may collect the required information and provided it to the API for subsequent query and the result of the query is delivered to the third party program for presentation by the third party program. Or the 3^{rd} party system may be modified directly to perform the data query and display the result. The 3^{rd} party system would have to abide by all security and authentication requirements. The API has the appearance to the system of being a User Subsystem with all the same capabilities and functions including authentication.

An example of a third party system that will utilize this API would be the police cruiser based vehicle registration query system. APIs are provided for user authentication, interaction with the administration services function, and data query access. The existing in cruiser software will be modified to optionally collect the routing key (Homing Tag) in addition to the already entered vehicle license plate number. The routing key (Homing Tag) and license plate number would be delivered to the API which would then perform the routing lookup and subsequent query. The returned query result would then be delivered to the third party software (modified through the use of the APIs to accept the query and result) where it would then be presented to the officer.

Business Method Scenarios Provided by this System

The preferred embodiment describes a System and Method for Internet based Instant Information Verification System (IIVS) providing real time automobile liability insurance verification. Reconfiguring the User Subsystem human interface (GUI or text display) and the Information request (data query) provide an Instant Background Check System (ICBS) using the same underlying method.

In all methods, all data requests require an indirection by using a homing tag lookup into the translation table (XT) also referred to as a network address table (NAT). In the preferred embodiment, the homing tag can not be used for direct routing. The specific network addresses are considered a security issue and are a restricted element (guarded secret) of the system. If a homing tag could be utilized for direct request routing then someone could create a counterfeit card and have the request route to their counterfeit database which would return a counterfeit response. The NAT in the user subsystem can only be updated and distributed by the administration function (CMS) thereby restricting update access to the routing capability. The distribution to end user segments is by secure connection after user validation.

In all methods, data requests received by the data servers are counted and measured against time resulting in queries per minute value. Data servers will maintain a local table of excluded users (access table with exclusion or “disallow” markings) attempting to perform more than N queries per minute. Any user which performs more than N queries per minute is added to the table or marked in the table as “disallowed” and a message is sent to the administration function with that User ID. The administration function will disallow system logins by that user. For each data request, the exclude table is viewed and if a user ID is present in that table, the user request is denied.

System and Method for Instant Liability Insurance Verification

The system and method for instant automotive liability insurance verification allows a remote location to perform data requests to any specific insurance issuing insurance company. The data request results in a real time query into the insurance company maintained insurance database and returns a time stamped response indicating the current status of the vehicle insurance.

Referring to FIG. 6, the Instant Liability Verification System (ILVS) is composed of the insurance card (5500), the remote user subsystem (5600), the public internet (5400), the DSS (5300) and the DSS database (5310), the CMS (5100) and the API interface to the the police cruiser based registration verification system (5000 and 5200). The system initiates a query by 5600 performing a scan of 5500 or by a policeman entering the license tag and optionally the homing tag displayed on the vehicle into the police cruiser based registration verification query system (5000) which performs it's query to the registration server (5200) which utilizes the API (5210) to perform the insurance verification query.

Fixed Location Verification

1. A paper proof of liability insurance card (5500)is provided to the vehicle owner (insured) as is done today however, the card contains a barcode based VIN and a barcode based unique Insurance company Homing Tag. The barcode information can be a single barcode containing both items or can be encoded in two lines.

2. A barcode scanner (contained within 5600) is used to scan the VIN and Homing Tag (one or two lines).

3. Under stored program control the Homing Tag is used as a lookup key in a locally stored translation table. The result of the lookup is the destination network address of the stored program control located at the specific data server subsystem (at the insurance company).

4. An information request package is built containing the Daycode, translation table ID, the sender ID and sender network address, and the VIN.

5. The information package (query) is sent from the initiating location to the specified destination network address (via UDP message).

6. At the destination (DSS, the insurance company), stored program control receives the information request and validates the security Daycode.

7. If the security Daycode is valid, the VIN or license plate number is used as a lookup key into the insurance company database.

8. The insurance company database is queried locally by the Data Server Subsystem stored program control at the insurance company.

9. The result of the insurance company database lookup (insurance current, expired, cancelled, not found) is constructed into a response package. The response package includes the security Daycode, the Sender ID, the date and time, the VIN and license plate number, and the insurance status.

10. The response package is transmitted across the network to the user network address (UDP) at the initiating location.

11. The package is received by the stored program control at the initiating location and the received Sender ID is compared to the real Sender ID.

12. If the Sender IDs match, the result (insurance valid, cancelled, expired, not found) is displayed.

Mobile Enforcement Verification

1. An insurance company Homing Tag (i.e. identifier sticker “ABC”) is applied to the license plate or back window of the vehicle so that it is visible to traffic to the rear. The sticker is provided to the vehicle owner (insured) along with the paper insurance card.

2. A patrol officer enters the license plate or VIN number of the vehicle into the in-vehicle automotive vehicle registration verification system as is typically done today. Optionally, in addition, the officer enters the Homing Tag information from the visible sticker (i.e. “ABC”).

3. Under the stored program control of the in vehicle registration system the Homing Tag is used as a lookup key in the locally stored translation table. The result of the lookup is the destination network address of the DSS associated with that insurance company.

4. Under the stored program control of the API in the vehicle registration system an information request package is built containing a security Daycode, the sender ID and sender network address, and the license plate number.

5. The information package (query) is sent from the initiating user location to the specified destination network address (via UDP message or TCP/IP connection).

6. At the destination (DSS, the insurance company), stored program control receives the information request and validates the security Daycode.

7. If the security Daycode is valid, the VIN and/or license plate number is use as a lookup key into the insurance company database.

8. The insurance company database is queried locally by the DSS stored program control at the insurance company.

9. The result of the insurance company database lookup (insurance current, expired, cancelled, not found) is constructed into a response package. The response package includes the security Daycode, the Sender ID, the VIN and/or license plate number, and the insurance status.

10. The response package is transmitted across the network to the User network address (via UDP or TCP/IP connection) that initiated the query.

11. The package is received by the stored program control at the initiating location (the in-vehicle registration verification system) and the received Sender ID is compared to the real Sender ID.

12. If the Sender IDs match, the result (insurance valid, cancelled, expired, not found) is displayed.

System Administration and Maintenance

The system administration and maintenance function generates a random number each day to be utilized as the security “day-code”. The system administration and maintenance function builds, updates, and distributes the network address table NAT (translation table) containing insurance company homing tag to insurance company DSS network address data entries.

Each insurance company DSS database is accessible via stored program control at the insurance company location. The contents of the database including maintenance of the database is the responsibility of the appropriate insurance company. The system administration and maintenance function pings each insurance company every 24 hours to verify it is on-line and to distribute the day security code (“day-code”). When each insurance company application receives the ping, it responds with a registration message containing its unique homing tag and network address. The response received from the insurance company is verified/updated in the NAT and a day-code message is sent to the insurance company application.

A new insurance company is brought on-line by the insurance company application sending a register message (authenticated message containing network address, homing ID, and unique authorization code) to the administration and maintenance function. The administration and maintenance function contains a user and a DSS authentication database for logins. The system administration and maintenance function validates the sender of the register message against the authentication database and acknowledges any validated (proper login/password sequence) unsolicited registration message with a message containing the day-code.

Users of the system must log in once each day. The system maintenance function includes a user authentication database where users enter a user ID and password. After successful verification of the username and password the NAT (translation table) and day-code are downloaded to the user application. The user application may now be used to perform data requests to all insurance companies listed in the NAT. After the 24 hour period a new day-code is generated by the CMS and distributed to the insurance company applications. User applications which utilize the stale day-code must perform the login function again to receive the new day-code and NAT.

It is a business method of this system to count data requests from each user over a period of time at the DSS (insurance company application) via a counter in the access list. Users which perform data requests at a rate greater than N (programmable value) per minute are denied system access at the insurance company application and a message is sent to the system maintenance function to log the ID of the user and disable the user login capability for M (Programmable value) minutes.

User Authentication

A user must be authenticated prior to allowing data server requests within the system.

1. Using stored program control at a user subsystem, a connection (TCP/IP) is created to the administration server (CMS) where the user is prompted to enter the user ID and password.

2. Upon successful authentication of user ID and password, the current day-code and NAT are transferred to the user subsystem.

3. The connection is terminated and the user subsystem may now begin data queries for the purpose of real time insurance verification.

Data Server Arrivals

A new data server (DSS) or a data server that was temporarily disabled or otherwise not accepting data queries may enter the system by interaction with the administration function.

1. A GUI at the administration function provides for manual entry of the homing tag and associated network address of the new data server subsystem (insurance company).

2. The homing tag is verified not to be a duplicate and the new network address is stored in the NAT (translation table).

3. A connection is made to the new network address and a day-code update message is sent.

4. Stored program control at the DSS location specified by the new network address receives and processes the day-code and acknowledges.

5. The connection is terminated and the data server subsystem (insurance company) can now process data queries.

Day-Code Updates

Periodically (preferably every 12 hours), the security day-code is updated.

1. The administration function generates a new day-code.

2. The Administration function reads each entry in the NAT and for each entry a connection is made to the network address and a day-code update message is sent.

3. Stored program control at the location specified by the network address receives and processes the day-code and acknowledges. Note that steps 2 and 3 constitute what is considered the “ping” function.

4. The connection is terminated and the data server subsystem (insurance company) can now process data queries using the new day-code.

5. To prevent user subsystem and data server subsystems being out of synchronization with respect to the day-code, the data server subsystem will process data requests by validation against the current and previous day-codes.

System and Method for Instant Identity Verification

The system and method for instant identity verification allows a user subsystem (remote location) to perform data requests to the specific issuing agency of the identity card, driver's license or passport. The data request can be initiated by any of the initiate means (barcode, magnetic stripe, optical character recognition, RFID, etc.) and the response from the issuing agency is the image of the individual and also an optional text message (i.e. “individual is a suspected terrorist or is a wanted felon, notify police immediately.”). Note that in the scenario of a suspected terrorist, the issuing agency response to the data request might contain stored program control which generates a message (i.e. email message) to a 3^{rd} party indicating “suspect xxxx just presented ID at xxxx location”).

Fixed Location Verification

1. A driver's license, personal identification card, passport, or preferred traveler identification card is issued to the individual. The card contains a magnetic strip, RFID encoded, embedded microprocessor or barcode based unique assigned individual identification code (i.e. SSN) and a unique data server Homing Tag. The barcode information can be a single barcode containing both items or can be encoded in two lines.

2. The appropriate reader (barcode, magnetic stripe, RFID, or processor reader) is used to scan the ID card to capture the id code and homing tag.

3. Under stored program control the Homing Tag is used as a lookup key in a locally stored Network Address Table (NAT). The result of the lookup is the destination network address of the stored program control located at the specific data server subsystem (specific agency issuing the id card or license).

4. An information request package is built containing a security Daycode, the sender ID and sender network address, and the id code and homing tag.

5. The information package (query) is sent from the initiating location (user subsystem) to the specified destination network address (i. e. via UDP message or secure VPN, etc.).

6. At the destination (issuing agency), stored program control receives the information request and validates the security Daycode.

7. If the security Daycode is valid, the user ID is use as a lookup key into the issuing agency database at the DSS.

8. The issuing agency database is queried locally by the stored program control at the issuing agency (DSS) database location.

9. The result of the database lookup (ID found, image of individual, ID not found) is constructed into a response package. The response package includes the security Daycode, the Sender ID, the status of the data query, and the stored image of the individual assigned the identification code.

10. The response package is transmitted across the network to the sender (user subsystem) network address (i.e. UDP, VPN, etc.) at the initiating location.

11. The package is received by the stored program control at the initiating location (user subsystem) and the received Sender ID is compared to the real Sender ID.

12. If the Sender IDs match, the image contained in the response is displayed allowing direct comparison of the database derived image against the person standing there with the id card.

Mobile Verification

The mobile method is the same as the fixed location method however it utilizes a wireless palm pilot, web enabled cellular phone, or any other wireless enabled computing platform which contains the required scanning interface or keyboard input ability and can execute the computer program of the user subsystem and display the received image contained within the response of the data query.

System Maintenance

System maintenance is the same as described in section “System Administration and Maintenance”.

System and Method for Instant Background Verification

The system and method for instant background verification allows a remote location (user subsystem) to perform data requests to any combination of local, state, and federal databases initiated from a single ID card scan or manual data entry. The single scan results in multiple database queries and displays the summary of the responses.

Fixed Location Verification

1. A driver's license, personal identification card, or preferred traveler identification card is issued to the individual. The card contains a magnetic strip, RFID encoded, embedded microprocessor or barcode based unique assigned individual identification code (i.e. SSN) and a unique data server Homing Tag. The barcode information can be a single barcode containing both items or can be encoded in two lines.

2. The appropriate reader (barcode, magnetic stripe, RFID, or processor reader) is used to scan the id card to capture the id code and homing tag.

3. Under stored program control the Homing Tag is used as a lookup key in a locally stored Network Address Table (NAT). The result of the lookup is the destination network address of the stored program control located at the specific data server (specific agency issuing the ID card or license).

4. An information request package (query) is built containing a security code, request type of “background check” the sender ID and sender network address, and the ID code and homing tag.

5. The information package (query) is sent from the initiating location (user subsystem) to the specified destination network address DSS (via UDP message or secure VPN, etc.).

6. At the destination DSS (issuing agency), stored program control receives the information request and validates the security Daycode.

7. If the security code is valid, the user ID is use as a lookup key into the issuing agency's database.

8. The issuing agency database is queried locally by the stored program control at the issuing agency DSS database location.

9. Upon successful completion of the issuing agency database data request, since the request type of “background check” was received stored program control at the issuing agency performs data requests to the FBI, department of public safety and other required agencies prior to returning the aggregate response to the initiating user segment.

10. The result of the secondary queries (database lookups) (id found, image of individual, id not found) is constructed into an aggregate response package by the issuing agency DSS stored program control. The response package includes the security code, the Sender ID, the status of the data query, and the stored images of the individual assigned the identification code (i.e. status of the data query is “individual background verified clean” or “felony conviction found at FBI”, etc.).

11. The response package is transmitted across the network to the sender network address (i.e. UDP, VPN, etc.) at the initiating location (initiating user subsystem).

12. The package is received by the stored program control at the initiating location and the received Sender ID is compared to the real Sender ID.

13. If the Sender IDs match, the image(s) contained in the response is(are) displayed allowing direct comparison of the database derived image against the person standing there with the id card and the status message is displayed (i.e. “individual background not located”, “individual background verified clean”, etc.).

As an alternative, a fingerprint or other bio-metric database exists at the DSS populated by a pre-registered traveler or purchaser and the data key is the result of a fingerprint or other bio-metric scanner. The control program at the user subsystem would perform a query to one or more static network addresses after receiving the data from a fingerprint or other bio-metric scanner.

Mobile Enforcement Verification

The mobile method is the same as the fixed location method however it utilizes a wireless palm pilot, web enabled cellular phone, or any other wireless enabled computing platform which can display the received images and text massages contained within the response of the data query.

System Maintenance

System maintenance is the same as described previously in section “System Administration and Maintenance”.

An overview of the system and method for automotive liability insurance compliance system is shown in FIG. 6.

There exist today tools designed to decrease the amount of time required to implement a system and methods such as are described in this patent application. Such tools provide a framework and building blocks with which to develop this system and methods, for example Web Services. There are also tools offered as individual building blocks by which to implement this system and methods, for example Java Beans and the various Java Enterprise components. It is understood by one skilled in the art that the system and methods described in this patent application are independent of the infrastructure upon or the environment within which the subsystems execute thus the system and methods implemented via Web Services or some other developmental tool is not an improvement over what is described here but rather a different implementation of the same system and methods.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system and Method for real time automotive insurance verification comprising
a. One or more subsystems providing user interface, data query initiation means, and query response display means;
b. One or more subsystems providing data server means containing queried data and providing the response to the data query.
c. A subsystem providing system administration and maintenance for the purpose of administering system access, updating routing tables, and collecting system statistics;
d. A common network means providing the foundation for query and response communication between said subsystems.

2. The system and method as set forth in claim 1 where said insurance verification is automobile liability insurance.

3. The system and method as set forth in claim 1 where said user subsystem utilizes bar code technology for process initiation.

4. The system and method as set forth in claim 1 where said user subsystem utilizes RFID technology for process initiation.

5. The system and method as set forth in claim 1 where said user subsystem network data query contains vehicle VIN and is initiated from VIN and Homing Tag

6. The system and method as set forth in claim 1 where said user subsystem network data query contains vehicle license plate number and is initiated from license plate number and Homing Tag.

7. The system and method as set forth in claim 1 where said user subsystem network data query contains vehicle license plate number and is initiated from license plate number and Homing Tag with Homing Tag extracted from the State Vehicle Registration Database.

8. The system and method as set forth in claim 1 where said user subsystem network data query route determination is the result of a translation of a routing Identifier said translation controlled by a translation control code.

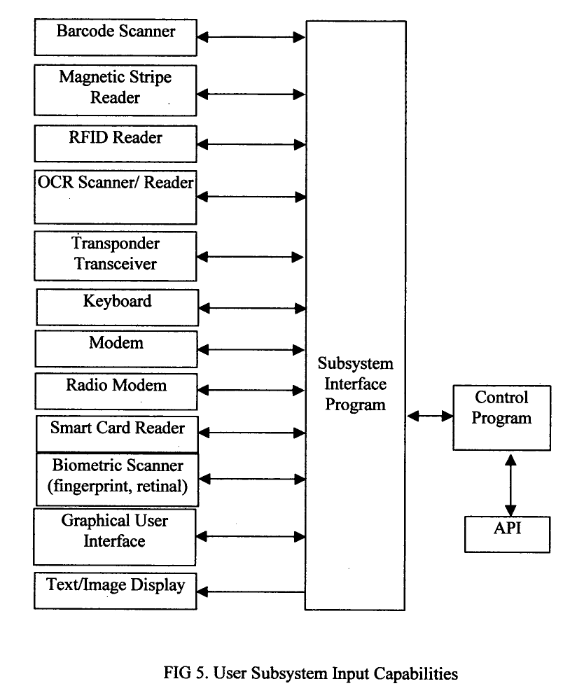

9. The system and method as set forth in claim 1 where said user interface query initiation is by any of the means shown in FIG. 5.

10. The system and method as set forth in claim 1 where said user subsystem authentication is good for more than one query.

11. A System and Method for real time identification validation and background check comprising:
a. One or more subsystems providing user interface, data query initiation means, and query response display means;
b. One or more subsystems providing data server means containing queried data and providing the response to the data query.
c. A subsystem providing control and maintenance for the purpose of administering system access, and collecting system statistics;
d. A common network means providing the foundation for query and response communication between said subsystems.

12. The system and method as set forth in claim 11 where said user interface performs multiple queries to multiple data server means initiated from a single id card scan and displays a response aggregated from the individual queries.
